(19) United States
(12) Patent Application Publication
(10) Pub. No.: US 2020/0340426 A1
(43) Pub. Date: Oct. 29, 2020

(54) THRUST REVERSER DOOR EQUIPPED WITH A PROJECTING SEAL AND AIRCRAFT PROPULSION UNIT COMPRISING SAID DOOR

(71) Applicant: Airbus Operations SAS, Toulouse (FR)

(72) Inventors: Frédéric CHELIN, TOULOUSE (FR); Guillaume CLAIRET, TOULOUSE (FR); Gabriel GALINDO FERNANDEZ, TOULOUSE (FR)

(21) Appl. No.: 16/855,298

(22) Filed: Apr. 22, 2020

(30) Foreign Application Priority Data
Apr. 26, 2019 (FR) 1904435

(51) Int. Cl. F02K 1/62

(52) U.S. Cl. CPC F02K 1/625

(57) ABSTRACT

A thrust reverser door for an aircraft propulsion unit, including a seal positioned at an upstream edge of the door. This seal includes a part that projects with respect to the upstream edge of the door and a rigid core to stiffen the projecting part. This configuration serves to reduce aerodynamic disturbances.

### CROSS-REFERENCES TO RELATED APPLICATIONS

This application claims the benefit of the French patent application No. 1904435 filed on Apr. 26, 2019, the entire disclosures of which are incorporated herein by way of reference.

### FIELD OF THE INVENTION

The present application relates to a thrust reverser door equipped with a projecting seal, and to a propulsion unit comprising the door.

### BACKGROUND OF THE INVENTION

According to one embodiment, shown in FIGS. 1 to 7, an aircraft 10 comprises multiple propulsion units 12 positioned beneath each one of the wings 14 of the aircraft 10 and connected to the latter by pylons 16. Each propulsion unit 12 comprises a jet engine positioned inside a nacelle 18. The jet engine is connected to the pylon 16 by engine attachments and comprises an engine core 20 and a fan 22.

For the remainder of the description, a longitudinal direction is parallel to the axis of rotation A22 of the fan 22 and a radial direction is perpendicular to the axis of rotation A22. A longitudinal plane is a plane containing the axis of rotation A22 and a transverse plane is a plane perpendicular to the axis of rotation A22. The concepts of forward/upstream and rearward/downstream refer to the direction of flow of a flow of air in the nacelle 18, this flowing from forward (from upstream) to rearward (downstream).

The nacelle 18 is approximately tubular in shape and delimits, with the engine core 20, an annular duct 24. The nacelle 18 comprises an upstream section 26 which is referred to as the air intake and is positioned forward of the fan 22, a median section 28 in which the fan 22 is positioned, and a downstream section 30 which has a trailing edge 32.

The nacelle 18 comprises a thrust reverser 34 that is positioned in the downstream section 30 and is configured to occupy an activated state in which it deflects, outward and forward of the nacelle 18, at least part of the flow of air flowing in the annular duct 24, and an inactivated state in which it does not deflect the flow of air flowing in the annular duct 24.

The thrust reverser 34 comprises at least one mobile part 36 which serves to create at least one lateral opening 38 (shown in FIGS. 4 and 6) toward which the deflected flow of air is oriented.

According to one embodiment, the mobile part 36 is an O-shaped tubular cowl which translates in the longitudinal direction between a closed position (shown in FIGS. 3 and 5) in which the mobile part 36 is in contact with the median section 28 when the thrust reverser 34 is in the inactivated state, and an open position (shown in FIGS. 4 and 6) in which the mobile part 36 is moved away from the median section 28 so as to create the lateral opening(s) 38 when the thrust reverser is in the activated state. The mobile part 36 comprises an outer wall 40 and an inner wall 42 that are connected at the trailing edge 32, the inner and outer walls 40, 42 delimiting between them a cavity 44 that is open in the direction of the median section 28.

The thrust reverser 34 also comprises doors 46 that are configured to deflect at least part of the flow of air flowing in the annular duct 24 in the direction of a lateral opening 38 and a plurality of gratings 48 positioned at the lateral opening 38 when the mobile part 36 is in the open position and in the cavity 44 when the mobile part 36 is in the closed position. These gratings 48 are distributed over the circumference of the nacelle 18 and are configured to control the orientation of the flow deflected by the door(s) 46.

Each door 46 is able to move between a folded-back position, shown in FIG. 5, when the thrust reverser is in the inactivated state and the mobile part 36 is in the closed position, in which the door 46 is clamped against the mobile part 36 and a deployed position, shown in FIG. 6, when the thrust reverser is in the activated state and the mobile part 36 is in the open position, in which the door 46 extends across the annular duct 24 so as to deflect at least part of the flow of air flowing therein in the direction of the lateral opening 38.

As shown in FIGS. 5 and 7, the median section 28 comprises an inner wall 50 which delimits the annular duct 24 and which has a rear edge 50.1 having a double curvature, a first curvature in a transverse plane and a second curvature in a longitudinal plane (as shown in FIGS. 5 to 7). This rear edge 50.1 is configured to orient the flow of air deflected by the door(s) 46 in the direction of the gratings 48.

Each door 46 provides a certain continuity between the inner wall 50 of the median section 28 and the inner wall 42 of the mobile part 36 when the door 46 is in the folded-back position. This door 46 comprises a first face 46.1 that is oriented in the forward direction when the door 46 is in the deployed position and towards the engine core 20 when it is in the folded-back position, and a second face 46.2 that is oriented in the rearward direction when the door 46 is in the deployed position and towards the mobile part 36 when it is in the folded-back position. The door 46 also comprises a first edge 46.3 that is oriented in the forward direction in the folded-back position and toward the mobile part 36 in the deployed position.

Given the kinematics of the door 46 between the folded-back and deployed positions, in order to reduce the risk of friction between the door 46 and the rear edge 50.1 of the median section 28, the first edge 46.3 of the door and the rear edge 50.1 of the median section 28 are spaced apart by a clearance J, in a radial direction, when the door 46 is in the folded-back position, as shown in FIG. 7. In order to reduce the clearance J, the first edge 46.3 of the door 46 is slightly curved towards the exterior of the nacelle 18.

In order to avoid the flow of air passing between the door 46 and the mobile part 36, the door 46 comprises a seal 52 which is made of elastomer and is positioned against the second face 46.2 at the first edge 46.3. In a transverse plane, this seal 52 has a U-shaped cross section and comprises a first branch 52.1 that is clamped against and secured to the second face 46.2 of the door 46, a second branch 52.2 that is in contact with the rear edge 50.1 of the median section 28 when the door 46 is in the folded-back position, and a base 52.3 that is oriented in the forward direction, setback in the rearward direction with respect to the first edge 46.3 of the door.

This configuration of the first edge 46.3 of the door and of the seal 52 generates a hollow shape 54 (delimited by dotted lines in FIG. 7) which extends over the entire circumference of the annular duct 24 and which gives rise to aerodynamic disturbances that affect the fuel consumption of the aircraft.

According to one embodiment described in document GB2395175, a thrust reverser door comprises, at its forward edge, an element that extends the door in the forward direction. This element comprises a first zone connected to the door and a second zone in contact with the rear edge of the inner wall of the nacelle when the door is in the folded-back position. Even though this solution makes it possible to eliminate the hollow shape, it is not entirely satisfactory because the seal must be of reduced length (that dimension considered in the longitudinal direction). Consequently, the forward edge of the door must be very close to the rear edge of the inner wall of the nacelle, which imposes particular shapes for the door and the inner wall and/or particular kinematics for the door.

### SUMMARY OF THE INVENTION

The present invention seeks to remedy all or some of the drawbacks of the prior art.

To that end, the invention relates to a thrust reverser door for an aircraft propulsion unit, the door being able to move between a folded-back position in which the door does not deflect a flow of air and a deployed position in which the door deflects a flow of air, the door having a first face in contact with the flow of air during operation, a second face opposite the first face and a first edge that is configured to be oriented, during operation, toward a fixed part when the door is in the folded-back position, the door comprising a seal positioned at the first edge, having a connection zone connected to the door and a projecting part that is offset in the forward direction with respect to the first edge when the door is in the folded-back position, the projecting part extending the first face of the door.

According to the invention, the seal comprises a rigid core to stiffen the projecting part that extends beyond the first edge of the door.

The projecting part of the seal serves to limit aerodynamic disturbances. In addition, the rigid core serves to stiffen the projecting part of the seal and as a consequence the first edge of the door can be spaced further apart from the fixed part compared to the prior art solutions.

According to another feature, the rigid core comprises a first zone positioned in the projecting part of the seal and a second zone positioned in the connection zone of the seal.

According to another feature, the rigid core has a length and at least one characteristic that is not constant over its length.

According to another feature, the rigid core comprises at least one notch that extends from an upstream edge of the rigid core.

According to another feature, the notches have dimensions that are adjusted so as to vary the non-constant characteristic of the rigid core.

According to another feature, the rigid core has dimensions that are adjusted so as to vary the non-constant characteristic of the rigid core.

According to another feature, the seal has a V-shaped cross section with a point, the V-shaped cross section consisting of first and second branches which have a junction zone that is offset in the upstream direction with respect to the first edge when the door is in the folded-back position.

According to another feature, the first branch comprises a first portion that is essentially straight and is clamped against the second face of the door, a second portion that is essentially straight in the extension of the door and a third portion that is curved and is interposed between the second portion and the point of the V-shaped cross section.

According to another feature, the rigid core does not extend at the second branch and at the third, curved portion of the first branch.

According to another feature, the first branch has a setback to accommodate part of the door in order that a first face of the first branch is in the continuation of the first face of the door.

According to another feature, the seal is made of elastomer and is overmolded onto the rigid core.

The invention also relates to an aircraft propulsion system comprising a thrust reverser door according to one of the preceding features.

### BRIEF DESCRIPTION OF THE DRAWINGS

Other features and advantages will emerge from the following description of the invention, which description is given solely by way of example, with reference to the appended drawings in which:

FIG. 1 is a perspective view of an aircraft,

FIG. 2 is a perspective view of a propulsion unit,

FIG. 3 is a side view of a propulsion unit fitted with a thrust reverser in the inactivated state,

FIG. 4 is a side view of the propulsion unit shown in FIG. 3, the thrust reverser being in the activated state,

FIG. 5 is a longitudinal section through part of the propulsion unit shown in FIG. 3, the thrust reverser being in the inactivated state,

FIG. 6 is a longitudinal section through part of the propulsion unit shown in FIG. 3, the thrust reverser being in the activated state,

FIG. 7 is a longitudinal section through part of a thrust reverser door shown in FIG. 5, illustrating a prior art embodiment,

FIG. 8 is a front view of part of a door of the thrust reverser shown in FIG. 5, illustrating an embodiment of the invention,

FIG. 9 is a longitudinal section through part of a door of the thrust reverser shown in FIG. 5, illustrating an embodiment of the invention,

FIG. 10 is a section through a seal of a door of a thrust reverser, illustrating an embodiment of the invention,

FIG. 11 is a rear view of a propulsion unit of an aircraft, illustrating an embodiment of the invention,

FIG. 12 is a perspective view of two doors of a thrust reverser and of two rigid cores illustrating an embodiment of the invention,

FIG. 13 is a perspective view of a rigid core, illustrating an embodiment of the invention,

FIG. 14 is a top view of a rigid core, illustrating an embodiment of the invention, and

FIG. 15 is a section through a seal of a door of a thrust reverser, illustrating another embodiment of the invention.

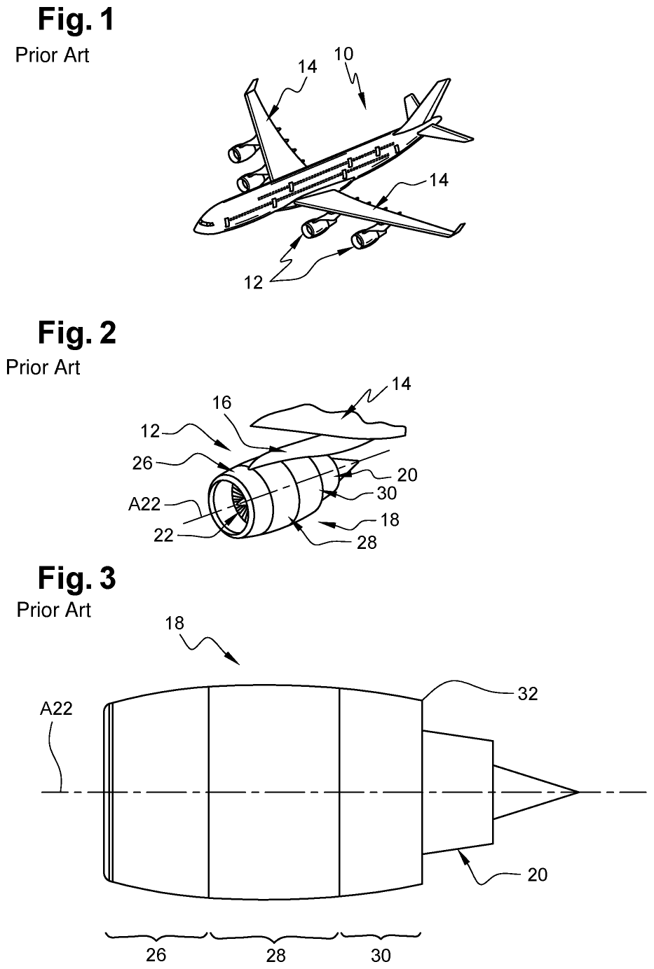

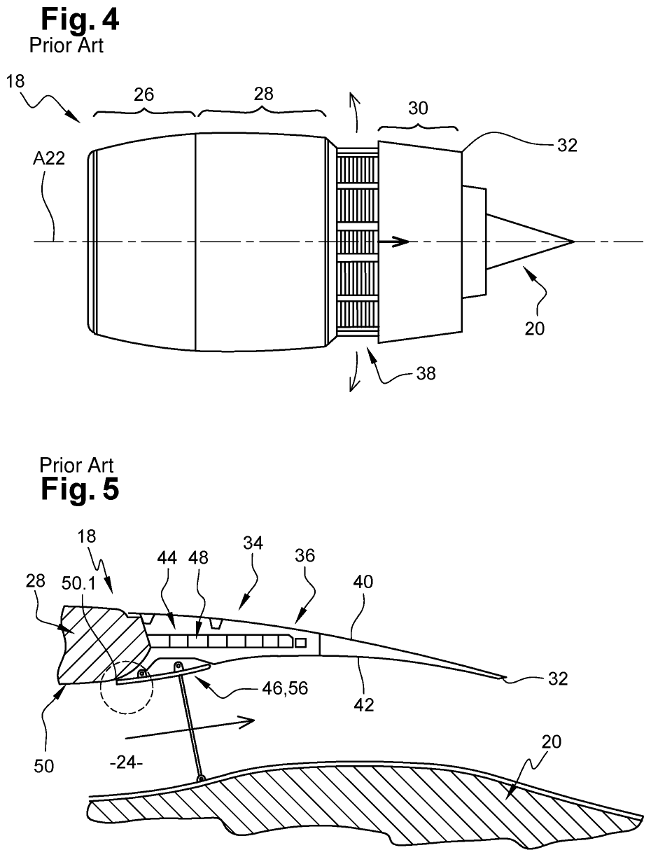

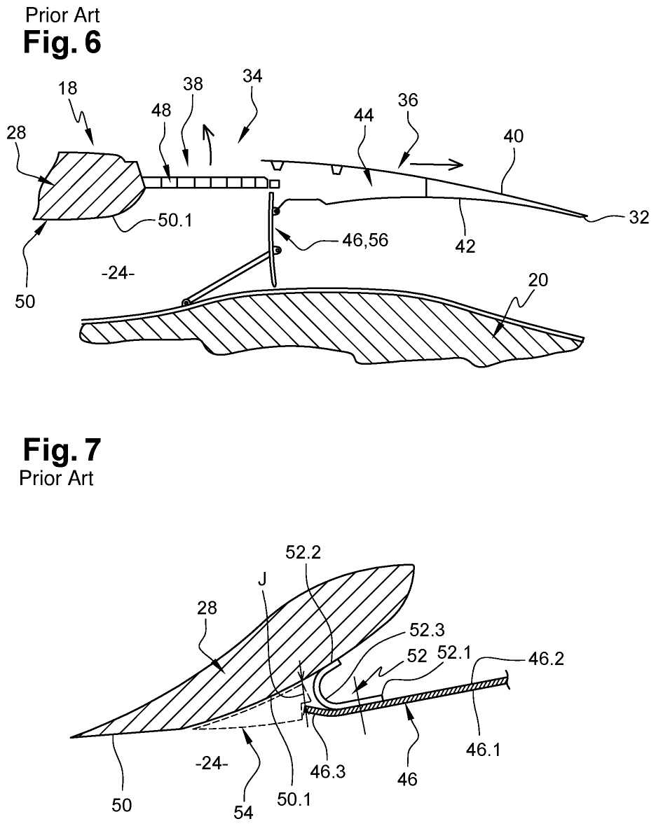

### DETAILED DESCRIPTION OF THE PREFERRED EMBODIMENTS

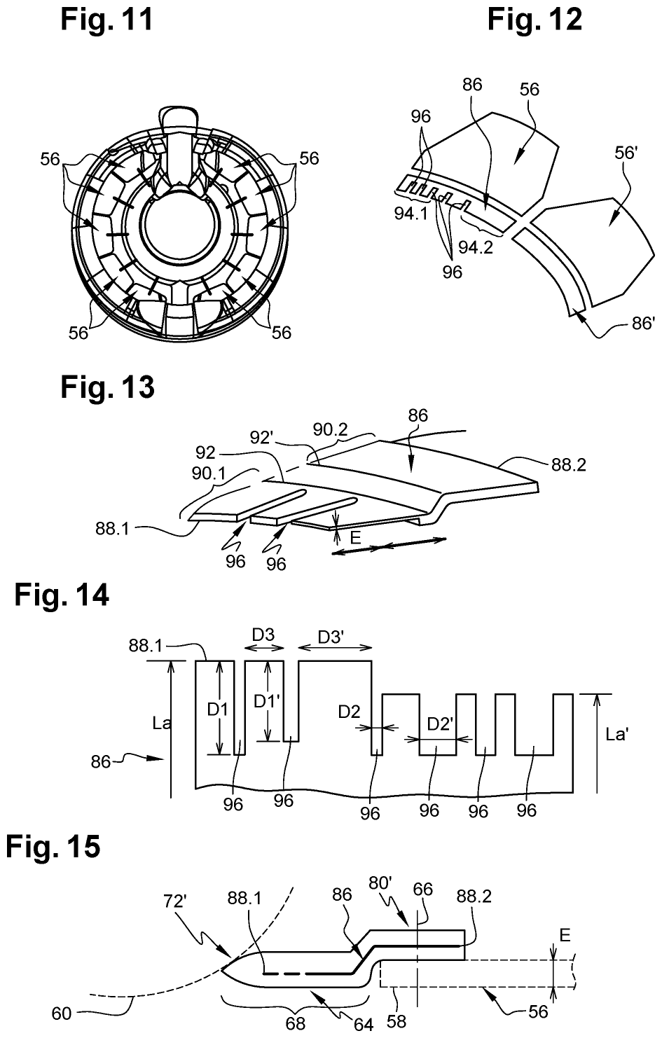

FIG. 11 shows multiple doors 56 of a thrust reverser of a propulsion unit of an aircraft, these doors being distributed over the circumference of the propulsion unit. According to a configuration shown in FIG. 12, the doors may differ from one another depending on their positions on the circumference of the propulsion unit.

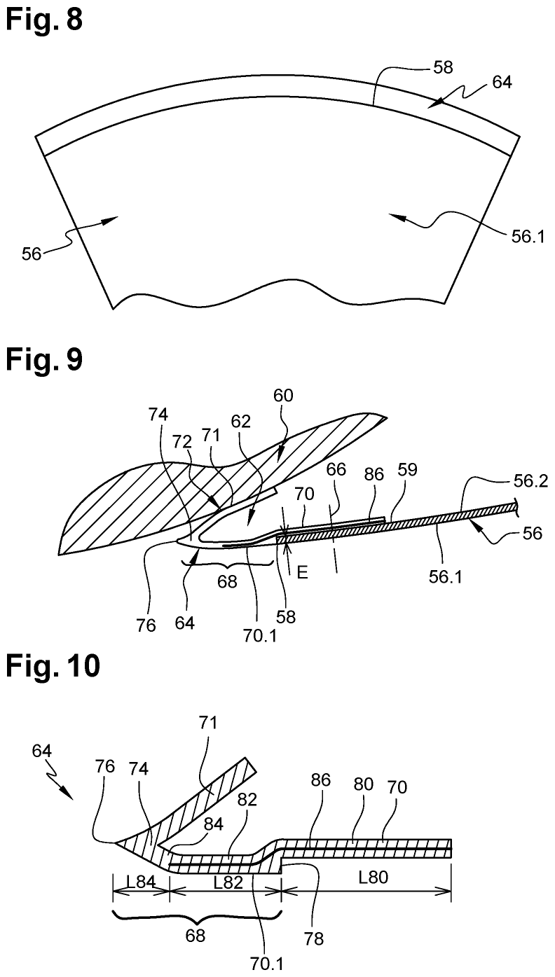

FIGS. 8 and 9 show part of a door 56 of a thrust reverser of a propulsion unit. The other elements of the propulsion unit are not described further since they may be identical to those of the prior art.

The door 56 comprises a first face 56.1 that is oriented in the forward direction when the door 56 is in the deployed position and towards the engine core 20 when it is in the folded-back position, and a second face 56.2, opposite the first face 56.1, that is oriented in the rearward direction when the door 56 is in the deployed position and towards the mobile part of the thrust reverser when it is in the folded-back position. In operation, the first face 56.1 is in contact with a flow of air.

The door 46 also comprises a first edge 58 that is oriented in the forward direction when it is in the folded-back position and toward the mobile part when it is in the deployed position.

According to one embodiment, the door 56 is in the form of a plate 59 having a thickness E at the first edge 58.

When the door 56 is in the folded-back position, the first edge 58 is at a small distance from a fixed part 60 which has a double curvature, a first curvature in a transverse plane and a second curvature in a longitudinal plane (as shown in FIG. 9). This fixed part 60 corresponds to the rear edge of the median section of the propulsion unit and it is configured to orient the flow of air deflected by the door 56 in the direction of the gratings.

Given the kinematics of the door 56 between the folded-back and deployed positions, in order to reduce the risk of friction between the door 56 and the fixed part 60, the first edge 58 of the door 56 and the fixed part 60 are spaced apart by a clearance J, in a radial direction, when the door is in the folded-back position, as shown in FIG. 9, and delimit a peripheral hollow shape 62 upstream of the door 56.

The door 56 comprises a seal 64 positioned at the first edge 58 and connected to the door 56 by securing elements 66. According to one configuration, shown in FIG. 8, the seal 64 extends over the entire length of the first edge 58 of the door 56.

The seal 64 comprises a projecting part 68 that is offset in the forward direction with respect to the first edge 58 when the door 56 is in the folded-back position, extending the first face 56.1 of the door 56, this projecting part 68 being configured so as to at least partially fill the hollow shape 62 delimited by the fixed part 60 and the door 56. Thus, the projecting part 68 serves to limit aerodynamic disturbances generated by the hollow shape 62 when a seal 64 is not present. When the door 56 is in the deployed position, the seal 64 reduces the clearance between the door 56 and the gratings.

According to one embodiment, shown in FIGS. 9 and 10, the seal 64 has a V-shaped cross section comprising a first branch 70 that is clamped against and secured to the second face 56.2 of the door 56, and a second branch 71 which forms a contact zone 72 in contact with the fixed part 60 when the door 56 is in the folded-back position. The first and second branches 70, 71 have a junction zone 74 that is offset in the forward direction with respect to the first edge 58 when the door 56 is in the folded-back position.

The projecting part 68 of the V-shaped cross section has a point 76.

The first branch 70 has a setback 78 configured to accommodate part of the door 56, more specifically, the plate 59 of the door 56. Thus, the first branch 70 comprises an outer face 70.1 in the continuation of the first face 56.1 of the door 56. This configuration serves to limit aerodynamic disturbances.

According to one configuration, at the projecting part 68, the first branch 70 comprises a first portion 80 that is essentially straight and is clamped against the second face 56.2 of the door 56, a second portion 82 that is essentially straight in the extension of the door 56, and a third portion 84 that is curved and is interposed between the second portion 82 and the point 76 of the V-shaped cross section, having a curvature oriented toward the exterior of the nacelle 18. This configuration serves to limit the risk of leakage between the seal 64 and the fixed part 60.

To give an order of magnitude, the first portion 80 has a width L80 that is essentially equal to the sum of the widths L82, L84 of the second and third portions 82, 84, and the second portion 82 has a width L82 essentially equal to twice the width L84 of the third portion 84.

The invention is not restricted to a V-shaped cross section for the seal 64.

According to another embodiment, shown in FIG. 15, the seal 64 is approximately flat and comprises a connection zone 80′ that is superposed and connected to the door 56 and a projecting part 68 which has a contact zone 72′ in contact with the fixed part 60 when the door 56 is in the folded-back position.

Thus, whatever the embodiment, the seal 64 comprises a connection zone 80, 80′ that is configured to be connected to the door 56 and a projecting part 68 which has a contact zone 72, 72′ in contact with the fixed part 60 when the door 56 is in the folded-back position.

According to another feature of the invention, the seal 64 comprises a rigid core 86 that is configured to stiffen the projecting part 68. According to one embodiment, the rigid core 86 is a metal (or clinking) blade having a thickness between 0.2 mm and 1 mm, preferably of the order of 0.3 mm, inserted into the first branch 70. According to one configuration, the rigid core 86 is embedded in the seal 64.

This rigid core 86 extends beyond the first edge 58 of the door 56 and serves to increase the stiffness of the projecting part 68 of the seal 64. Thus, the first edge 58 of the door 56 can be spaced further apart from the fixed part 60, compared to the prior art solutions.

According to the embodiment shown in FIGS. 9 and 10, the rigid core 86 is inserted into the first branch 70 extends over the first and second portions 80 and 82. The rigid core 86 is not present in the second branch 71 and in the third portion 84 in order for the seal 64 to retain its capacity to deform so as to follow the geometry of the fixed part 60.

According to the embodiment shown in FIG. 15, the rigid core 86 is inserted into the connection zone 80′ and into the projecting part 68.

Whatever the embodiment, the rigid core 86 is positioned in the projecting part 68. According to certain embodiments, the rigid core 86 can extend at the connection zone 80, 80′.

Each rigid core 86 comprises an upstream edge 88.1 that is approximately perpendicular to the longitudinal direction, and a downstream edge 88.2 that is approximately parallel to the upstream edge 88.1. In operation, the upstream edge 88.1 is oriented toward the fixed part 60.

According to a configuration shown in FIG. 13, the rigid core 86 comprises a first zone 90.1 which extends from the upstream edge 88.1 and is positioned in the projecting part 68 of the seal 64, and a second zone 90.2 which extends from the downstream edge 88.2 and is positioned in the connection zone 80, 80′ of the seal 64. The rigid core 86 has two bending lines 92, 92′ which are approximately parallel to the upstream and downstream edges 88.1, 88.2, separating the first and second zones 90.1, 90.2 in order for the rigid core 86 to follow the profile of the seal 64.

According to one embodiment, the seal 64 is made of elastomer and is overmolded onto the rigid core 86.

For the remainder of the description, the width of an element corresponds to the dimension of the element considered along the longitudinal direction, and the length of the element corresponds to its dimension considered along the circumference.

According to one embodiment which is not shown, the rigid cores 86 of the seals 64 of the various doors 56 are all identical.

According to another embodiment, shown in FIG. 12, a first rigid core 86 of a first door 56 is different from a second rigid core 86′ of a second door 56′.

According to one embodiment, the rigid core 86 comprises at least one characteristic that is not constant over its length. Thus, the rigid core 86 comprises at least one first zone 94.1 having at least one characteristic that is different from that of a second zone 94.2, the first and second zones 94.1, 94.2 being offset along the length. According to one embodiment, the flexibility of the rigid core 86 may vary over its length.

According to one embodiment, which is shown in FIGS. 12 to 14, a rigid core 86 comprises at least one notch 96 which extends over part of the width of the rigid core 86. Each notch 96 extends in a longitudinal direction, starting from the upstream edge 88.1.

Each notch 96 has a first dimension D1, D1′, considered along the width of the rigid core 86, and a second dimension D2, D2′, considered along the length of the rigid core 86. Two successive notches 96 are separated by a third dimension D3, D3′.

This makes it possible to adjust the flexibility of the rigid blade 86, by varying at least one of the first, second and third dimensions of the notches 96. Of course, the invention is not restricted to this embodiment in order to vary the flexibility of the rigid core 86. This makes it possible to adjust the flexibility of the rigid core 86 by varying at least one of the dimensions of the rigid core 86, in particular its width La, La′, as shown in FIG. 14, or its thickness E, as shown in FIG. 13.

The fact of being able to adjust at least one characteristic of the rigid core 86 over its length makes it possible to be able to adjust at least one characteristic of the seal 64, in particular its suppleness, over its length.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A thrust reverser door for an aircraft propulsion unit, said door being configured to move between a folded-back position in which the door does not deflect a flow of air and a deployed position in which the door deflects a flow of air, said door comprising:
a first face in contact with the flow of air during operation,
a second face opposite the first face, and
a first edge that is configured to be oriented, during operation, toward a fixed part when the door is in the folded-back position,
a seal positioned at the first edge, having a connection zone connected to the door and a projecting part that is offset in a forward direction with respect to the first edge when the door is in the folded-back position, the projecting part extending the first face of the door,
wherein the seal comprises a rigid core to stiffen the projecting part that extends beyond the first edge of the door.

2. The thrust reverser door as claimed in claim 1, wherein the rigid core comprises a first zone positioned in the projecting part of the seal and a second zone positioned in the connection zone of the seal.

3. The thrust reverser door as claimed in claim 1, wherein the rigid core has a length and at least one characteristic that is not constant over the length.

4. The thrust reverser door as claimed in claim 3, wherein the rigid core comprises at least one notch that extends from an upstream edge of the rigid core.

5. The thrust reverser door as claimed in claim 4, wherein the notches have dimensions that are adjusted so as to vary the non-constant characteristic of the rigid core.

6. The thrust reverser door as claimed in claim 3, wherein the rigid core has dimensions that are adjusted so as to vary the non-constant characteristic of the rigid core.

7. The thrust reverser door as claimed in claim 1, wherein the seal has a V-shaped cross section with a point, said V-shaped cross section comprising first and second branches which have a junction zone that is offset in an upstream direction with respect to the first edge when the door is in the folded-back position.

8. The thrust reverser door as claimed in claim 7, wherein the first branch comprises a first portion that is essentially straight and is clamped against the second face of the door, a second portion that is essentially straight in an extension of the door and a third portion that is curved and is interposed between the second portion and the point of the V-shaped cross section.

9. The thrust reverser door as claimed in claim 8, wherein the rigid core does not extend at the second branch and at the third, curved portion of the first branch.

10. The thrust reverser door as claimed in claim 7, wherein the first branch has a setback to accommodate part of the door in order that a first face of the first branch is in a continuation of the first face of the door.

11. The thrust reverser door as claimed in claim 1, wherein the seal is made of elastomer and is overmolded onto the rigid core.

12. A propulsion unit comprising a thrust reverser door as claimed in claim 1.
